(19) United States
(12) Patent Application Publication
(10) Pub. No.: US 2026/0186328 A1
(43) Pub. Date: Jul. 2, 2026

(54) CORNER REFLECTOR WITH MODULATION ARRANGEMENT

(71) Applicant: Telefonaktiebolaget LM Ericsson (publ), Stockholm (SE)

(72) Inventors: Henrik SJÖLAND, Lund (SE); Muris SARAJLIC, Malmö (SE); Magnus SANDGREN, Staffanstorp (SE)

(21) Appl. No.: 19/129,237

(22) PCT Filed: Nov. 14, 2022
(86) PCT No.: PCT/EP2022/081820

§ 371 Date: May 12, 2025

(51) Int. Cl. G02F 1/01

(52) U.S. Cl. CPC G02F 1/0123; G02F 2203/50

(57) ABSTRACT

A corner reflector with modulation arrangement is disclosed. According to one aspect, a corner reflector having three panels includes a plurality of planar antenna elements configured on each panel to receive, modulate and reflect an incident electromagnetic wave. The corner reflector also includes biasing circuitry configured to provide a common bias voltage to each of at least a subset of the plurality of planar antenna elements. The corner reflector further includes at least one diode at each planar antenna element, each diode having a common bias voltage and configurable to be one of forward-biased and reverse-biased according to the common bias voltage.

### TECHNICAL FIELD

The present disclosure relates to wireless communications, and in particular, to a corner reflector with modulation arrangement.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Standards for Sixth Generation (6G) communication systems are in development.

In addition to these standards, the Institute of Electrical and Electronic Engineers (IEEE) has developed and continues to develop standards for other types of wireless communication networks, including Wireless Local Area Networks (WLANs), including Wireless Fidelity (Wi-Fi) networks. WLANS include wireless communication between access points (APs) and WDs.

Currently, standards are being developed to extend the range of milli-meter wave (mm-wave) communication. Narrow beams are favorable for extending the range of mm-wave and sub-tera-Hertz (THz) communication systems. Narrow beams also increase capacity by allowing greater spatial multiplexing. The trend is to use higher and higher operating frequencies in wireless communication systems, and the higher the operating frequency, the more opportune it is to form narrow beams. Beam scanning techniques are used to find beam pairs between access points and devices.

Back-scattering communication is increasing in ultra-low power applications. A backscattering device does not need to generate a high frequency carrier, which is the major power consumer in a transmitter. No carrier frequency power amplifier, oscillator or mixer are needed in the backscattering device. Instead, the backscattering device modulates the scattering properties of its antenna, which is illuminated by a high frequency carrier, either by the access point, radio base station, or other unit having a radio frequency transmitter, hereafter referred to as a network node. By modulating a received signal, the backscattering device backscatters (reflects) a modulated signal that can be demodulated at a receiving device. The backscattering device typically modulates the incident electromagnetic field by changing the load impedance of the antenna, to alter the phase and/or amplitude of the reflected signal. The backscattering device can then operate at the modulation frequency rather than the carrier frequency, which typically differ by several orders of magnitude. The power consumption can then be extremely low, so that the device can operate on harvested power, or operate the targeted life-time on a very small battery without replacing it.

As operating frequencies increase, narrow beams will be used, increasingly. The search space for finding a transmit-receive beam pair will accordingly increase. The beams should be updated more frequently when devices move or change position, as even small changes may cause a narrow beam to miss its target.

Backscattering is used mainly at low frequencies, as the link budget at higher frequencies becomes less favorable. At mm-wave and THz frequencies, beamforming is used by some communication systems, but an ultra-low power backscattering device beamforming would be very challenging to implement. This means that back-scattering applications will be limited to low frequency bands, limiting backscatter techniques to operators that have access to such frequency bands and to equipment that support such frequencies. Furthermore, spatial selectivity at higher frequencies cannot be utilized, which would otherwise allow devices to be selectively illuminated by directing a narrow illumination beam toward them.

### SUMMARY

Some embodiments advantageously provide a corner reflector with a modulation arrangement.

A corner reflector, where each surface is covered by an antenna array is provided. Each signal port of each antenna element is loaded by at least one diode, connected between the antenna signal port and signal ground. The signal ground can be arranged as ground planes on printed circuit boards (PCBs), one for each surface of the corner reflector. The antennas may also be connected to a similarly designed plane with a common bias voltage, and by adjusting the common bias voltage, the diodes may be forward or reverse biased, providing different load impedances to the antenna element ports. A bias plane can be connected to a point of the antenna where the voltage amplitude is very small for both polarizations, close to the antenna center for a patch antenna. In this case, tuning the high frequency impedance of the bias feed becomes less of an issue.

For a certain bias voltage, with the diodes forward biased, the antennas will be terminated close to their characteristic impedance, and the maximum energy will be transferred to the diode load. The reflected signal amplitude will then be minimum. When the bias is instead low, so that the diodes operate at zero bias or in reverse bias, the diode impedance will be mainly capacitive, and limited energy will be transferred to them by the antennas, and more power will instead be reflected. Also, when more forward bias is applied, more power will be reflected, as the diodes then become more low ohmic, thereby presenting an impedance mismatch. Depending on characteristics of the used diodes and the parasitics of the circuit board interconnect, the reflection of the corner reflector structure can be characterized versus bias voltage, and the proper settings for minimum and maximum reflection can be found. These settings for entering an absorbing or a reflecting mode, can be used for on-off keying (OOK) modulation of the reflected wave.

Corner reflectors are known in radar and work by reflecting an incoming wave at three perpendicular surfaces, by which the incoming wave is reflected back in the direction from which it came. Because of this property, a rather small reflector has a large monostatic radar cross section (RCS). Such reflectors may be designed using sheet metal for the surfaces. The angle of incidence will be different for the three surfaces, and for some incoming wave directions, some surfaces may receive the incident signal at close to zero degrees from the normal direction while other surfaces receive the incident signal at almost 90 degrees. Regardless of incoming direction, however, at least one surface will receive the incoming wave from a direction where the antennas on the surface can receive it well. Significant energy is thus extracted from the wave when the structure is in the absorbing mode. This ensures that the absorbing mode is functional. At surfaces where the angle of the incident wave is close to 90 degrees from the normal direction, if any, the antennas are poor at receiving the signal, and the wave will be well reflected regardless of impedance of antenna termination. Some surfaces then reflect using antenna reception and re-radiation, whereas other surfaces not functioning well as antennas for that angle just reflect the radiation. All surfaces then reflect and the corner reflector is functional.

The modulated corner reflector can be controlled by a single bias voltage. If the modulation frequency is limited, the power consumption can be very low. Then the corner reflector may be used in a mm-wave or THz backscatter device. Being a reflector, the radar cross section can be large, supporting significant distance of communication although the frequency is high. Another use is to aid beam search, by presenting a target with a large radar cross section and a distinguishable modulation characteristic at the access points. This enables a wireless device, (WD) to target and track the direction to the access point using its beams.

A corner reflector is built using three antenna arrays. A diode is connected between each antenna port and signal ground. Each patch antenna is connected to a common bias voltage, applied near the center of the antenna. By controlling the bias voltage, common to all antennas, the magnitude of the reflected wave can be modulated. It is also possible to use the diodes in reverse bias and modulate the bias voltage, to modulate the capacitance and thereby the phase of the reflected wave. The modulation can be used for backscatter communication, or for identification of the reflector for positioning or beam search/tracking.

Some embodiments may provide one or more of the following advantages:
Single voltage control;
Large, reflected wave magnitude;
May be used for mm-wave and THz backscatter communication;
May be used for positioning;
May be used for beam search and tracking; and/or
May use a patch antenna symmetry point for bias, which simplifies the biasing network.

According to one aspect, an active corner reflector for modulating and reflecting an incident electromagnetic wave is provided. The active corner reflector includes a plurality of panels positioned to form a corner reflector, each panel having an array of antenna elements, each panel being configurable to receive, modulate and reflect the incident electromagnetic wave via at least one diode at each of a first plurality of antenna elements of the array, the diodes at each antenna element of the first plurality of antenna elements being biased by a first common bias voltage.

According to this aspect, in some embodiments, the plurality of panels form a trihedral structure. In some embodiments, the active corner reflector further includes a second conductive layer to deliver the first common bias voltage to the first plurality of antenna elements. In some embodiments, a panel of the plurality of panels further includes an antenna element layer that includes the array of antenna elements, a first dielectric layer adjacent the antenna element layer, and a first conductive layer adjacent the first dielectric layer. In some embodiments, the diodes are located adjacent the first conductive layer on a side of the first conductive layer that is opposite the first dielectric layer. In some embodiments, the panel of the plurality of panels further includes a second dielectric layer adjacent the first conductive layer, and a second conductive layer adjacent the second dielectric layer, the second conductive layer configured to deliver the first common bias voltage to each antenna element of the first plurality of antenna elements. In some embodiments, the panel of the plurality of panels further includes: first conductors, each first conductor configured to connect an antenna element of the panel to a corresponding at least one diode; and second conductors, each second conductor configured to connect an antenna element of the panel to the first common bias voltage. In some embodiments, the active corner reflector further includes biasing circuitry configured to provide the first common bias voltage to the first plurality of antenna elements of the array and a second common bias voltage to a second plurality of antenna elements of the array. In some embodiments, the biasing circuitry is configured alternate the first and second common bias voltages between reverse-biasing diodes at the first plurality of antenna elements while forward-biasing diodes at the second plurality of antenna elements and forward biasing diodes (72) at the first plurality of antenna elements (66) while reverse-biasing diodes (72) at the second plurality of antenna elements (66). In some embodiments, the reverse-bias diodes remain in a reverse-biased state while the forward-biased diodes remain in a forward-biased state for a duration of time to discriminate between polarizations of the incident electromagnetic wave. In some embodiments, the biasing circuitry is configurable to forward-bias the diodes and reverse-bias the diodes to modulate a magnitude of the incident electromagnetic wave. In some embodiments, the biasing circuitry is configurable to provide at least one of a plurality of forward bias levels and a plurality of reverse bias levels to modulate a phase of the incident electromagnetic wave. In some embodiments, the biasing circuitry is configurable to apply different modulations to different polarization ports of the array of antenna elements. In some embodiments, the biasing circuitry is configurable to apply a modulation only when a power of the incident electromagnetic wave exceeds a threshold. In some embodiments, the diodes at the first plurality of antenna elements of the array are configured to modify the incident signal according to at least one notch in a frequency response of the diodes.

According to another aspect, a trihedral active corner reflector having three panels is provided. The trihedral active corner reflector includes a plurality of planar antenna elements configured on each panel to receive, modulate and reflect an incident electromagnetic wave. The trihedral active corner reflector also includes biasing circuitry configured to provide a common bias voltage to each of at least a subset of the plurality of planar antenna elements. The trihedral active corner reflector further includes at least one diode at each planar antenna element, each diode having a common bias voltage and configurable to be one of forward-biased and reverse-biased according to the common bias voltage.

According to this aspect, in some embodiments, the biasing circuitry is configurable to provide forward-biasing of the diodes and reverse-biasing the diodes to modulate a magnitude of the incident electromagnetic wave. In some embodiments, the biasing circuitry is configurable to provide at least one of a plurality of forward bias levels and a plurality of reverse bias levels to modulate a phase of the incident electromagnetic wave. In some embodiments, the biasing circuitry is configurable to provide a plurality of modulation levels. In some embodiments, the biasing circuitry is configurable to apply different modulations to different polarization ports of the planar antenna elements. In some embodiments, the biasing circuitry is configurable to apply a modulation only when a power of the incident electromagnetic wave exceeds a threshold. In some embodiments, each panel further includes an antenna element layer that includes the planar antenna elements, a first dielectric layer adjacent the antenna element layer, and a first conductive layer adjacent the first dielectric layer, the diodes being located adjacent the first conductive layer on a side of the first conductive layer that is opposite the first dielectric layer. In some embodiments, each panel further includes a second dielectric layer adjacent the first conductive layer, and a second conductive layer adjacent the second dielectric layer, the second conductive layer configured to deliver the common bias voltage to the diodes at the planar antenna elements. In some embodiments, each panel further includes: first conductors, each first conductor via configured to connect a planar antenna element to a corresponding at least one diode; and second conductors, each second conductor configured to connect a planar antenna element to the common bias voltage.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system according to principles disclosed herein;

FIG. 2 is a block diagram of a network node in communication with a wireless device over a wireless connection according to some embodiments of the present disclosure;

FIG. 3 illustrates a trihedral active corner reflector with three panels of planar antenna elements arranged in an array;

FIG. 4 illustrates a panel of the trihedral active corner reflector;

FIG. 5 illustrates four square patch antennas with locations for diode connections and biasing connections; and

FIG. 6 illustrates a side view of a portion of a panel having planar patch antennas configured to be biased by biasing circuitry.

### DETAILED DESCRIPTION

Before describing in detail example embodiments, it is noted that the embodiments reside primarily in combinations of apparatus components and processing steps related to a corner reflector with modulation arrangement. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals. The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

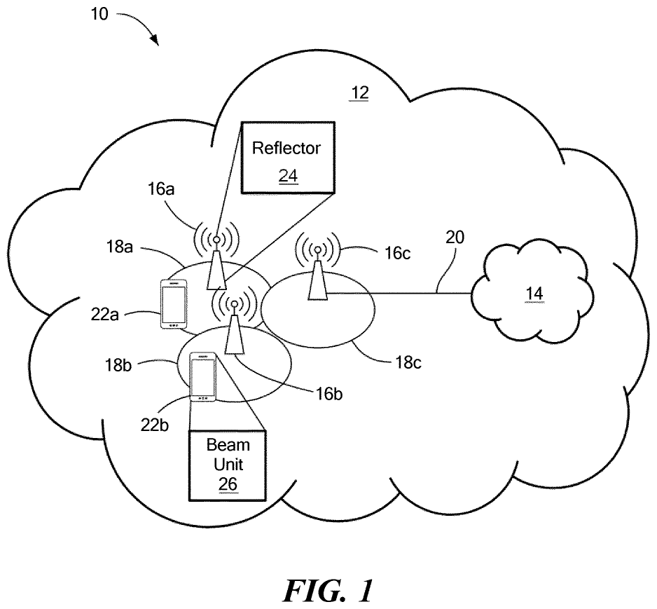

Some embodiments are directed to a corner reflector with modulation arrangement. Referring to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A network node 16 (eNB or gNB) is configured to include a corner reflector 24 which is configured to receive, modulate and reflect an incident electromagnetic wave to produce a modulated reflected wave. The corner reflector may be located in proximity to the network node 16. A wireless device 22 is configured to transmit an electromagnetic wave that may be modulated and reflected back toward the wireless device 22 by the corner reflector 24. The wireless device 22 may be preconfigured to know how the wave that it transmits will be modulated if received by the corner reflector 24. Thus, the WD 22 may sweep a transmit beam through an angular range. For each direction in the angular range, beam unit 26 of the WD 22 may determine if the signal received by the WD 22 in that direction is modulated in the expected way. If so, the WD 22 ascertains that the network node is in that direction.

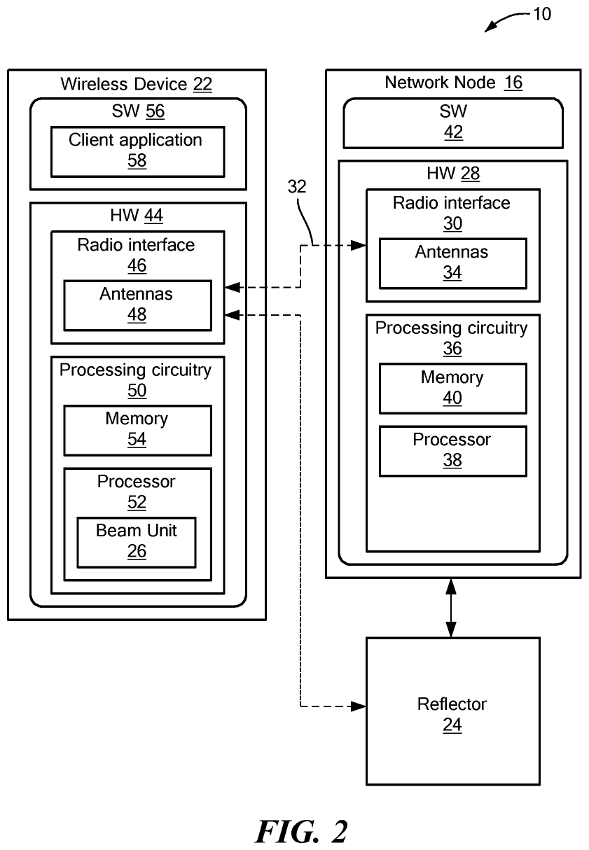

Example implementations, in accordance with an embodiment, of the WD 22 and network node 16 discussed in the preceding paragraphs will now be described with reference to FIG. 2.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include the corner reflector 24 which is configured to receive, modulate and reflect an incident electromagnetic wave.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include a beam unit 26 which is configured to determine if the signal received by the WD 22 in that direction is modulated in the expected way. If so, the WD 22 ascertains that the network node is in that direction.

In some embodiments, the inner workings of the network node 16 and WD 22 may be as shown in FIG. 2 and independently, the surrounding network topology may be that of FIG. 1.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 1 and 2 show various “units” such as beam unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

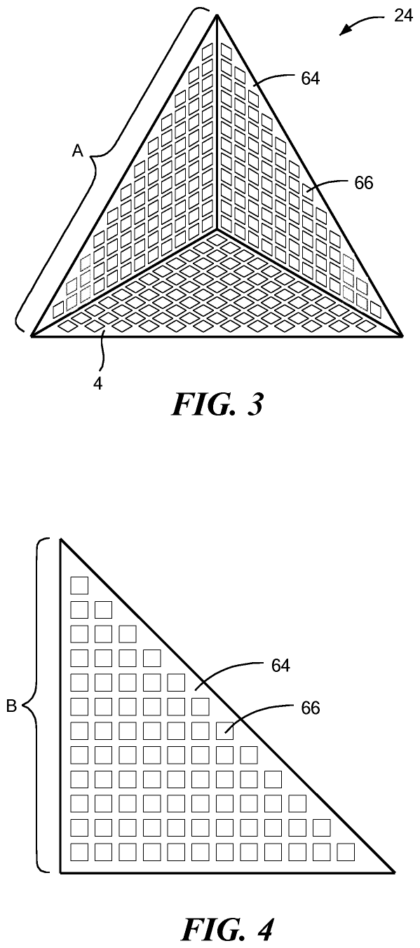

FIG. 3 shows a corner reflector 24 with triangular surfaces or panels 64. Each panel 64 includes an array of antennas 66 which may be planar antennas or patch antennas. FIG. 4 shows a face of one of the three panels 64. Each panel 64 has a long edge A (shown in FIG. 3) and a short edge B (shown in FIG. 4). Each antenna 66 may be configured to receive and transmit one or two orthogonal polarizations, corresponding to two antenna ports located at perpendicular edges of an antenna 66. Note that although rectangular antennas are show, other differently-shaped antennas can be used, such as circular or rectangular antennas.

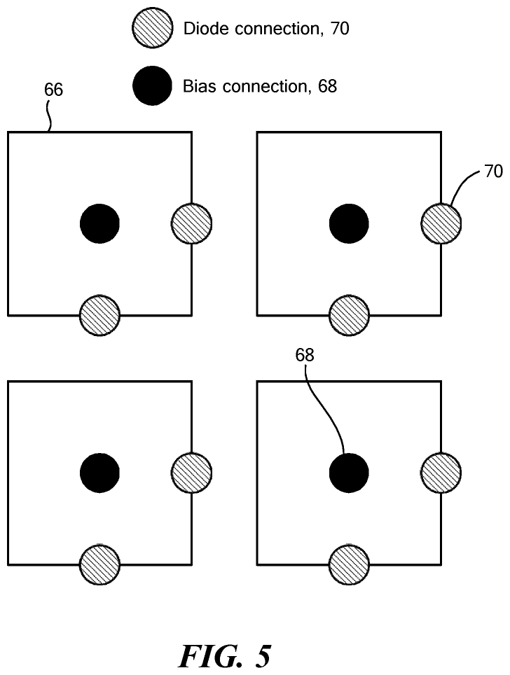

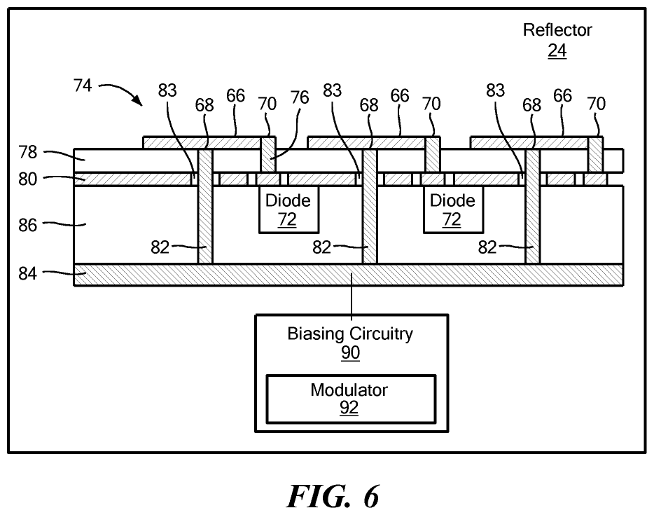

FIG. 5 is a top view of four square antennas 66 having biasing connections 68 to provide a bias voltage to bias diodes 72 (shown in FIG. 6) and having diode connections 70 to connect each diode 72 to the antenna 66. In some embodiments, there may only be one diode 72 per antenna 66 and in some embodiments, there may be more than one diode 72 per antenna 66. In the case of two diodes 72 on orthogonal sides of the antenna 66, as shown in FIG. 5, wave reflection for either polarization can be modulated by applying a modulated bias voltage to the bias connection 68. Note that planar antennas or patch antennas having a configuration that other than square, such as rectangular, circular or irregular shape, for example, may be implemented according to the principles disclosed herein to modulate an incident signal to produce a modulated reflected signal.

FIG. 6 shows a cross section of a portion of a printed circuit board (PCB) assembly 74 showing three planar or patch antennas 66, although there will typically be more than three antennas 66 on a panel 64. Instead of a PCB, other substrates may be employed, such as low temperature co-fired ceramics (LTCC). Each antenna 66 has a bias connection 68 and at least one diode connection 70. Each diode connection 70 connects an antenna 66 to a diode 72 via a first conductor 76 that passes through a first dielectric layer 78 and through a first conductive layer 80. The bias connections 68 may be connected by a second conductor 82 passing through the first conductive layer 80 through an insulating via 83 to a second conductive layer 84 so that a common biasing voltage may be distributed from the second conductive layer 84 to the antennas 66. The first dielectric layer 78 is between the antennas 66 and the first conductive layer 80 and the diode 72 is placed on the opposite side of the first conductive layer 80. By placing the diodes 72 on the opposite side of the first conductive layer 80, the first dielectric layer 78 can be made thinner, thereby reducing the distance between the antenna 66 and the first conductive layer 80, which reduces parasitic impedances in the vias 70. A second dielectric layer 86 between the first conductive layer 80 and the second conductive layer 84 may be sufficiently thick to allow the diodes 72 to be embedded therein.

The first conductive layer 80 and the second conductive layer 84 are configured to be in communication with biasing circuitry 90 which outputs the common biasing voltage to the second conductive layer 84, such that the operation of the diodes 72 is controlled by the difference between the voltage applied to the first conductive layer 80 and the common biasing voltage applied to the second conductive layer 84. The biasing circuitry 90 may include a modulator 92 which is configured to modulate the common biasing voltage. The diodes 72 can be oriented in a direction that presents a minimum parasitic capacitance towards the antenna 66. Two states of a diode 72 may then be either a positive-biased state or a negative-biased state with respect to the voltage of the first conductive layer 80. All diodes 72 are preferably oriented the same way, i.e., with the same terminal towards the antenna 66.

In some embodiments, the diodes 72 have a capacitance and a conductance that varies according to a level of bias voltage of the diodes 72. The modulator 92 may then tune the terminating impedances of the antennas 66, which in turn enables amplitude and phase modulation of the incident signal to produce a modulated reflected signal. In one embodiment, there are N possible values of terminating impedance and the modulator 92 can perform an N-level amplitude-and-phase modulation of the incident signal to cause reflection of a modulated version of the incident signal.

In some embodiments, load impedances for each diode 72 are designed to be as nearly equal as practicable and to have a distinct frequency response together with impedances in the carrier (PCB). For example, the impedance can be designed as a notch filter with one or more frequency notches, that depend on bias voltage. In these embodiments, the incident signal is modified to produce a reflected signal that is modified in the frequency domain with a modulated or programmable spectral content.

In some embodiments, the modulation is not applied to all antenna ports identically. For example, antenna ports for horizontal polarization can receive one modulation level while antenna ports for vertical polarization can receive a different modulation level. For example, an on-off keying (OOK) modulation pattern: ON-OFF-ON-OFF-ON-OFF . . . etc., can be implemented. In the ON mode the horizontal ports may be set to absorption and the vertical ports to reflection, while in the OFF mode the vertical ports may be set to absorption and the horizontal to reflection, or vice versa. In some embodiments, one set of polarization ports (e.g., horizontal) is always in absorption mode, whereas the other set of polarization ports (e.g., vertical) is always in reflection mode; that is, the modulator 92 does not perform a time-varying modulation, but effectively filters one of the polarizations. In some embodiments, the modulator 92 is programmable to control which polarization to reflect at a given time.

In some embodiments, the modulator 92 performs the modulation of the incident signal continuously to produce a continuously modulated reflected signal. The modulation pattern may be an infinite periodic repetition of a core (kernel) modulation sequence. In some embodiments, the modulator 92 performs modulation only when illuminated by an incoming signal of substantial power. For example, biasing circuitry 90 may include an analog energy detector which is configured to measure the energy of incoming signals and initiate the modulating operation by the modulator 92 only when the measured energy is above a pre-configured threshold.

The above-described embodiments enable a receiver of the reflected signal to determine if the received signal has been reflected by the corner reflector 24 and not from some other object or direction.

### Link Budget Example for 300 GHz Beam Finding

Assume a short edge B of length a=2 cm for a corner reflector 24, so that the long edge A is 2*sqrt(2)=2.8 cm. Assume a wavelength of lambda=3e8/300e9=1 mm. Then, the radar cross section is 4*pi*a\hat{ }4/(3*lambda\hat{ }2)=0.67 square meters. If the device searching for the beam direction has the following parameters:

−5 dBm output power per antenna;

256 antennas (256=24 dB); and
5 dB antenna element gain;
   then, the equivalent isotropic received power (EIRP) is-5+24+5+24=48 dBm.

Assume further that the receiving device has a 20 dB noise figure, and 64 antenna elements (64=18 dB). To find the presence of the corner reflector 24, assume a radar pulse length of 100 ns (−70 dBs). The noise floor then becomes-174+20+70 dB=−84 dBm. The received power at a distance of 10m is:

$$received power = EIRP + receiver antenna gain + 10 * log ( lambda \hat{} 2 * RCS / ( 4 * pi ) \hat{} 3 * distance \hat{} 4 ) = 48 + 23 + 10 * log ( 1 e - 6 * 0.67 / ( 4 * pi ) \hat{} 3 * 10 \hat{} 4 ) = 48 + 23 - 135 = - 64 dBm .$$

$$Signal to noise ratio SNR = - 64 -- 94 = 20 dB$$

Therefore, the presence of the corner reflector 24 at a 10m distance with a 100 ns pulse can be detected. If the corner reflector 24 has some loss due to the modulation, for example, the pulse length of the incident field can be increased slightly to compensate for this loss. For instance, if the loss is 3 dB, the pulse can be made twice as long (200 ns, in this example).

Since there is a risk that the corner reflector 24 is in the absorbing state when a signal is received from the WD 22, multiple measurements by the WD 22 may be performed. If Manchester coding is used, one pulse is guaranteed to occur in a reflecting state when three radar pulses are transmitted at the Manchester modulation rate. In some embodiments, the reflectors are modulated during slots known to the WD 22, to allow quick localization.

To find the identity of the signal, and to allow for timing synchronization, a longer radar pulse without amplitude modulation can be directed towards the corner reflector 24. The reflector 24 will modulate the reflection using a known sequence or a periodic repetition thereof. The magnitude of a correlation of the signal received by the WD 22 to known sequences are then calculated. For amplitude modulated reflections, the magnitude of the received signal versus time is first filtered and converted into a digital series of 0 and 1. This series is then compared to different sequences of modulation for different access points, and also different time shifts of these sequences. When a good match is found, the identity of the access point is found, as well as the coarse time synchronization.

If the modulation rate is 1M symbols per second, the radar can use a 1 us correlation time for each symbol. A fine tuning of the location of the 1 us correlation window start time may first be performed for the maximum detected symbol strength. In the example above, a 30 dB SNR would result from a 10×-longer integration, increasing the signal to noise ratio (SNR) from 20 dB to 30 dB. Then, transmit power that is ten time lower may be employed. Or power back-off of power amplifiers in the radio interface 46 of the WD 22 may be reduced to a factor of 4 rather than a factor of 10, to compensate for imperfect absorption in the modulated reflector that degrades the OOK modulation depth. This example shows that the modulated reflector is feasible for beam finding at 300 GHz.

According to one aspect, an active corner reflector 24 for modulating and reflecting an incident electromagnetic wave is provided. The active corner reflector 24 includes a plurality of panels 64 positioned to form a corner reflector 24, each panel 64 having an array of antenna elements 66, each panel 64 being configurable to receive, modulate and reflect the incident electromagnetic wave via at least one diode 72 at each of a first plurality of antenna elements 66 of the array, the diodes 72 at each antenna element 66 of the first plurality of antenna elements 66 being biased by a first common bias voltage.

According to this aspect, in some embodiments, the plurality of panels 64 form a trihedral structure. In some embodiments, the active corner reflector 24 further includes a second conductive layer 84 to deliver the first common bias voltage to the first plurality of antenna elements 66. In some embodiments, a panel 64 of the plurality of panels 64 further includes an antenna element layer that includes the array of antenna elements 66, a first dielectric layer 78 adjacent the antenna element layer, and a first conductive layer 80 adjacent the first dielectric layer 78, the diodes 72 being located adjacent the first conductive layer 80 on a side of the first conductive layer 80 that is opposite the first dielectric layer 78. In some embodiments, the panel 64 of the plurality of panels 64 further includes a second dielectric layer 86 adjacent the first conductive layer 80, and a second conductive layer 84 adjacent the second dielectric layer 86, the second conductive layer 84 configured to deliver the first common bias voltage to each antenna element 66 of the first plurality of antenna elements 66. In some embodiments, the panel 64 of the plurality of panels 64 further includes: first conductors 76, each first conductor 76 configured to connect an antenna element 66 of the panel 64 to a corresponding at least one diode 72; and second conductors 82, each second conductor 82 configured to connect an antenna element 66 of the panel 64 to the first common bias voltage. In some embodiments, the active corner reflector 24 further includes biasing circuitry 90 configured to provide the first common bias voltage to the first plurality of antenna elements 66 of the array and a second common bias voltage to a second plurality of antenna elements 66 of the array. In some embodiments, the biasing circuitry 90 is configured alternate the first and second common bias voltages to reverse-bias diodes 72 at the first plurality of antenna elements 66 while forward-biasing diodes 72 at the second plurality of antenna elements 66. In some embodiments, the reverse-bias diodes 72 remain in a reverse-biased state while the forward-biased diodes 72 remain in a forward-biased state for a duration of time to discriminate between polarizations of the incident electromagnetic wave. In some embodiments, the biasing circuitry 90 is configurable to forward-bias the diodes 72 and reverse-bias the diodes 72 to modulate a magnitude of the incident electromagnetic wave. In some embodiments, the biasing circuitry 90 is configurable to provide at least one of a plurality of forward bias levels and a plurality of reverse bias levels to modulate a phase of the incident electromagnetic wave. In some embodiments, the biasing circuitry 90 is configurable to apply different modulations to different polarization ports of the array of antenna elements 66. In some embodiments, the biasing circuitry 90 is configurable to apply a modulation only when a power of the incident electromagnetic wave exceeds a threshold. In some embodiments, the diodes 72 at the first plurality of antenna elements 66 of the array are configured to modulate the incident signal according to at least one notch in a frequency response of the diodes 72.

According to another aspect, a trihedral active corner reflector 24 having three panels 64 is provided. The trihedral active corner reflector 24 includes a plurality of planar antenna elements 66 configured on each panel 64 to receive, modulate and reflect an incident electromagnetic wave. The trihedral active corner reflector 24 also includes biasing circuitry 90 configured to provide a common bias voltage to each of at least a subset of the plurality of planar antenna elements 66. The trihedral active corner reflector 24 further includes at least one diode 72 at each planar antenna element, each diode 72 having a common bias voltage and configurable to be one of forward-biased and reverse-biased according to the common bias voltage.

According to this aspect, in some embodiments, the biasing circuitry 90 is configurable to provide forward-biasing of the diodes 72 and reverse-biasing the diodes 72 to modulate a magnitude of the incident electromagnetic wave. In some embodiments, the biasing circuitry 90 is configurable to provide at least one of a plurality of forward bias levels and a plurality of reverse bias levels to modulate a phase of the incident electromagnetic wave. In some embodiments, the biasing circuitry 90 is configurable to provide a plurality of modulation levels. In some embodiments, the biasing circuitry 90 is configurable to apply different modulations to different polarization ports of the planar antenna elements 66. In some embodiments, the biasing circuitry 90 is configurable to apply a modulation only when a power of the incident electromagnetic wave exceeds a threshold. In some embodiments, each panel 64 further includes an antenna element layer that includes the planar antenna elements 66, a first dielectric layer 78 adjacent the antenna element layer, and a first conductive layer 80 adjacent the first dielectric layer 78, the diodes 72 being located adjacent the first conductive layer 80 on a side of the first conductive layer 80 that is opposite the first dielectric layer 78. In some embodiments, each panel 64 further includes a second dielectric layer 86 adjacent the first conductive layer 80, and a second conductive layer 84 adjacent the second dielectric layer 86, the second conductive layer 84 configured to deliver the common bias voltage to the diodes 72 at the planar antenna elements 66. In some embodiments, each panel 64 further includes: first conductors 76, each first conductor 76 via configured to connect a planar antenna element 66 to a corresponding at least one diode 72; and second conductors 82, each second conductor 82 configured to connect a planar antenna element 66 to the common bias voltage.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
EIRP Effective Isotropic Radiated Power
OOK On Off Keying
PCB Printed Circuit Board
RCS Radar Cross Section
Rx Receiver
SNR Signal to Noise Ratio
Tx Transmitter

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. An active corner reflector for modulating and reflecting an incident electromagnetic wave, the active corner reflector comprising:
a plurality of panels positioned to form a corner reflector, each panel having an array of antenna elements, each panel being configurable to receive, modulate and reflect the incident electromagnetic wave via at least one diode at each of a first plurality of antenna elements of the array, the diodes at each antenna element of the first plurality of antenna elements being biased by a first common bias voltage; and
biasing circuitry configured to provide the first common bias voltage to the first plurality of antenna elements of the array and a second common bias voltage to a second plurality of antenna elements of the array, the biasing circuitry being configurable to apply different modulations to different polarization ports of the array of antenna elements.

2. (canceled)

3. The active corner reflector of claim 1, further comprising a second conductive layer to deliver the first common bias voltage to the first plurality of antenna elements.

4. The active corner reflector of claim 1, wherein a panel of the plurality of panels further includes an antenna element layer that includes the array of antenna elements, a first dielectric layer adjacent the antenna element layer, and a first conductive layer adjacent the first dielectric layer.

5. The active corner reflector of claim 1, wherein the diodes are located adjacent the first conductive layer on a side of the first conductive layer that is opposite the first dielectric layer.

6. The active corner reflector of claim 4, wherein the panel of the plurality of panels further includes a second dielectric layer adjacent the first conductive layer, and a second conductive layer adjacent the second dielectric layer, the second conductive layer configured to deliver the first common bias voltage to each antenna element of the first plurality of antenna elements.

7. The active corner reflector of claim 6, wherein the panel of the plurality of panels further includes:
first conductors, each first conductor configured to connect an antenna element of the panel to a corresponding at least one diode; and
second conductors, each second conductor configured to connect an antenna element of the panel to the first common bias voltage.

8. (canceled)

9. The active corner reflector of claim 8, wherein the biasing circuitry is configured to alternate the first and second common bias voltages between reverse-biasing diodes at the first plurality of antenna elements while forward-biasing diodes at the second plurality of antenna elements and forward biasing diodes at the first plurality of antenna elements while reverse-biasing diodes at the second plurality of antenna elements.

10. The active corner reflector of claim 8, wherein the reverse-bias diodes remain in a reverse-biased state while the forward-biased diodes remain in a forward-biased state for a duration of time to discriminate between polarizations of the incident electromagnetic wave.

11. The active corner reflector of claim 8, wherein the biasing circuitry is configurable to forward-bias the diodes and reverse-bias the diodes to modulate a magnitude of the incident electromagnetic wave.

12. The active corner reflector of claim 8, wherein the biasing circuitry is configurable to provide at least one of a plurality of forward bias levels and a plurality of reverse bias levels to modulate a phase of the incident electromagnetic wave.

13. (canceled)

14. The active corner reflector of claim 8, wherein the biasing circuitry is configurable to apply a modulation only when a power of the incident electromagnetic wave exceeds a threshold.

15. The active corner reflector of claim 1, wherein the diodes at the first plurality of antenna elements of the array are configured to modify the incident signal according to at least one notch in a frequency response of the diodes.

16. A trihedral active corner reflector having three panels, the trihedral active corner reflector comprising:
a plurality of planar antenna elements configured on each panel to receive, modulate and reflect an incident electromagnetic wave;
biasing circuitry configured to provide a common bias voltage to each of at least a subset of the plurality of planar antenna elements; and
at least one diode at each planar antenna element, each diode having a common bias voltage and configurable to be one of forward-biased and reverse-biased according to the common bias voltage, the biasing circuitry being configurable to apply different modulations to different polarization ports of the planar antenna elements.

17. The trihedral active corner reflector of claim 16, wherein the biasing circuitry is configurable to provide forward-biasing of the diodes and reverse-biasing the diodes to modulate a magnitude of the incident electromagnetic wave.

18. The trihedral active corner reflector of claim 16, wherein the biasing circuitry is configurable to provide at least one of a plurality of forward bias levels and a plurality of reverse bias levels to modulate a phase of the incident electromagnetic wave.

19. (canceled)

20. The trihedral active corner reflector of claim 16, wherein the biasing circuitry is configurable to apply a modulation only when a power of the incident electromagnetic wave exceeds a threshold.

21. The trihedral active corner reflector of claim 16, wherein each panel further includes an antenna element layer that includes the planar antenna elements, a first dielectric layer adjacent the antenna element layer, and a first conductive layer adjacent the first dielectric layer, the diodes being located adjacent the first conductive layer on a side of the first conductive layer that is opposite the first dielectric layer.

22. The trihedral active corner reflector of claim 21, wherein each panel further includes a second dielectric layer adjacent the first conductive layer and a second conductive layer adjacent the second dielectric layer, the second conductive layer configured to deliver the common bias voltage to the diodes at the planar antenna elements.

23. The trihedral active corner reflector of claim 22, wherein each panel further includes:
first conductors, each first conductor configured to connect a planar antenna element to a corresponding at least one diode; and
second conductors, each second conductor configured to connect a planar antenna element to the common bias voltage.
